(19) United States
(12) Patent Application Publication
(10) Pub. No.: US 2010/0225661 A1
(43) Pub. Date: Sep. 9, 2010

(54) METHOD FOR COMPUTER-AIDED VISUALIZATION OF THE RISK STATUS IN A TECHNICAL PROJECT

(76) Inventors: Andre Görisch, Furth (DE); Oliver Mäckel, Heimstetten (DE); Björn Rúther, Dortmund (DE); Alexander Sturm, Mulheim an der Ruhr (DE)

Correspondence Address: King & Spalding LLP, 401 Congress Avenue, Suite 3200, Austin, TX, 78701, US

(21) Appl. No.: 12/715,427

(22) Filed: Mar. 2, 2010

(30) Foreign Application Priority Data
Mar. 3, 2009 (EP) 09003042

(51) Int. Cl. G06T 11/20; G09G 5/02; G09G 5/00

(52) U.S. Cl. 345/589; 345/440.2; 345/634

(57) ABSTRACT

In a method for computer-aided visualization of a risk status in a technical project for developing or producing a technical system, components or a process, a number of risks and/or a number of uncertainties are provided as first and/or second input variables, each risk being assigned an occurrence probability and a damage degree and each uncertainty being assigned a weighting and an estimate of damage. Furthermore, a visually distinguishable bar chart having a first and second sector for the first and second input variables is generated. For each risk, the first sector has a bar segment in which the probability-of-occurrence and the degree-of-damage variables are depicted, and for each uncertainty of the number of uncertainties, the second sector has a bar segment in which the weighting and the estimate-of-damage variable are depicted. In a circular bar chart, the corresponding bars for the risks or uncertainties are highlighted in different colors.

### CROSS-REFERENCE TO RELATED APPLICATIONS

This application claims priority to EP Patent Application No. 09003042 filed Mar. 3, 2009, the contents of which is incorporated herein by reference in its entirety.

### TECHNICAL FIELD

The invention relates to a method for the computer-aided visualization of the risk status in a technical project for developing or producing a technical system, technical components or a technical process.

### BACKGROUND

The analysis of risks is crucially important for the control and evaluation of projects or for the manufacture of technical products or technical installations. A large number of risks are evaluated, both qualitatively and quantitatively, in the context of risk analysis for a technical project, and a suitably meaningful visualization of these risks is required.

The publication US 2007/0255583 A1 discloses a method for risk analysis, in which qualitative and quantitative evaluations of risks are visualized on the basis of diagrams, in order thereby to identify implausible risks in particular, where there is a high discrepancy between qualitative and quantitative evaluation.

In conventional risk-analysis methods, consideration is mainly given to risks in the real sense, representing calculable uncertainties, which are specified in a suitable manner by means of a probability of occurrence and a level of damage if the risk occurs. Here and in the following, the term “risk” is also used in the sense that it represents a calculable uncertainty. However, and particularly during early phases of a technical project, there are also risks in the broader sense which are not calculable. Here and in the following, such risks are designated as uncertainties. For the purpose of risk-analysis methods which also include such uncertainties in the analysis, it is desirable to visualize both the calculable risks and the uncertainties in a suitable manner.

### SUMMARY

According to various embodiments, a method for computer-aided visualization of the risk status in a technical project can be created, by means of which an observer is informed in a simple and intuitive manner of the risk status, including risks and uncertainties.

According to an embodiment, a method for the computer-aided visualization of the risk status in a technical project for developing or producing a technical system, technical components or a technical process, may comprise the steps of:
a number of risks are provided as first input variables and/or a number of uncertainties are provided as second input variables, each risk being assigned a probability of occurrence and a degree of damage if the risk occurs and each uncertainty being assigned a weighting and an estimate of damage if the uncertainty occurs;
a bar chart having a first sector for the first input variables and/or a second sector for the second input variables is generated on the basis of the first and/or second input variables, wherein the first and second sectors are visually distinguishable;
for each risk of the number of risks, the first sector comprises a bar segment in which the probability-of-occurrence variable and the degree-of-damage variable of the relevant risk are depicted in a visually distinguishable manner by means of bars;
for each uncertainty of the number of uncertainties, the second sector comprises a bar segment in which the weighting variable and the estimate-of-damage variable are depicted in a visually distinguishable manner by means of bars.

According to a further embodiment, the weighting of a particular uncertainty can be ascertained on the basis of a degree of predictability and a degree of influencability, wherein the weighting is composed of an unpredictability which is an inverse variable to the degree of predictability, and an uninfluencability which is an inverse variable to the degree of influencability. According to a further embodiment, the weighting of a particular uncertainty in the corresponding bar segment can be represented by a bar which is composed of a bar section for the uninfluencability and a bar section for the unpredictability, wherein the two bar sections are preferably visually distinguishable. According to a further embodiment, a bar in a first direction may represent the probability of occurrence and a bar in a second, opposite direction may represent the level of damage, within a bar segment of a relevant risk. According to a further embodiment, a bar in a first direction may represent the weighting and a bar in a second, opposite direction may represent the estimate of damage, within a bar segment of a relevant uncertainty. According to a further embodiment, in the bar chart—those bars representing probabilities of occurrence may have a first color; —those bars representing levels of damage may have a second color; —those bars representing weightings may have a third color or a pair of colors comprising a fourth and fifth color; —wherein the first to third colors or the first to fifth colors may have different colors. According to a further embodiment, the bar section for the uninfluencability may have the fourth color and the bar section for the unpredictability may have the fifth color. According to a further embodiment, the bar chart can be a circular diagram, wherein the first sector is a first circle sector and/or the second sector is a second circle sector, and a bar segment in the form of a bar circle segment is provided for each risk and/or each uncertainty. According to a further embodiment, the first and second circle sectors can be separated from each other by two separation circle segments. According to a further embodiment, the circular diagram may comprise a ring that is visually distinguishable from the bars and is divided into respective ring segments which are assigned to the bar circle segments. According to a further embodiment, one bar for the probability of occurrence and one bar for the degree of damage can be provided for a respective ring segment which is assigned to a bar circle segment representing a risk, wherein one bar extends outwards from the relevant ring segment in a radial direction of the circular diagram, and the other bar extends inwards in a radial direction of the circular diagram. According to a further embodiment, one bar for the weighting and one bar for the estimate of damage can be provided for a respective ring segment which is assigned to a bar circle segment representing an uncertainty, wherein one bar may extend outwards from the relevant ring segment in a radial direction of the circular diagram and the other bar extends inwards in a radial direction of the circular diagram. According to a further embodiment, an evaluation of the risk assigned to the ring segment or of the uncertainty assigned to the ring segment can be visually depicted in a respective ring segment. According to a further embodiment, the visual depiction of the evaluation can be achieved by means of gray shades and/or color shades of the surface of the ring segment. According to a further embodiment, the evaluations may be qualitative evaluations of the risks and/or the uncertainties. According to a further embodiment, the circular diagram may comprise an outer ring with respective outer ring segments that are assigned to the bar circle segments for the first and/or second circle sector, wherein a quantitative evaluation of the risk or uncertainty is visualized in the relevant outer ring segments based on the bars of the corresponding bar circle segment, wherein the quantitative evaluation is preferably divided into a plurality of classes and the respective class of the evaluation is preferably depicted by the color of the relevant outer ring segment. According to a further embodiment, the background of the circular diagram can be dark, and in particular black, and the bars stand out from this background by virtue of their coloring. According to a further embodiment, information about the technical project can be given in the center of the circular diagram. According to a further embodiment, a scale, in particular in the form of continuous circular lines, can be visualized in the bars of the bar chart. According to a further embodiment, a logarithmic scale can be visualized in bars that represent degrees of damage or estimates of damage, and a linear scale can be visualized in bars that represent probabilities of occurrence or weightings. According to a further embodiment, the risk status after planning of measures to reduce the project risk can be visualized in the bar chart, wherein the risks and/or uncertainties after implementation of the planned measures are visualized by respective bars. According to a further embodiment, at least some of the risks and/or uncertainties before the implementation of the planned measures can be visualized in the bar chart. According to a further embodiment, the relevant bars can be overlaid by second bars that depict in each case the variable represented by the respective bar before the implementation of the planned measures, wherein that part of a respective second bar which extends beyond the bar concerned is depicted such that it can be visually distinguished from the bar concerned. According to a further embodiment, the visual representations of the two bars can be inverted in the event that the respective second bar is lower than the bar concerned. According to a further embodiment, the measure costs of the planned measures can be visualized in the bar chart. According to a further embodiment, a user can set markers in the bar chart for the purpose of highlighting risks and/or uncertainties.

According to another embodiment, a computer program product may comprise program code which is stored on a machine-readable medium, for implementing one of the above described methods when the program runs on a computer.

### BRIEF DESCRIPTION OF THE DRAWINGS

An exemplary embodiment is described in detail below with reference to the appended FIG. 1.

FIG. 1 shows a preferred form of a representation of the risk status of a project, generated using an embodiment of the method.

### DETAILED DESCRIPTION

In the method according to an embodiment, a number of risks are provided as first input variables and/or a number of uncertainties are provided as second input variables, each risk being assigned a probability of occurrence and a degree of damage if the risk occurs and each uncertainty being assigned a weighting and an estimate of damage if the uncertainty occurs. The degree of damage of a risk is preferably the monetary loss. The estimate of damage for an uncertainty represents an approximate evaluation of the damage, wherein the estimate-of-damage variable is preferably also a monetary variable. The weighting of an uncertainty represents a degree of relevance of the uncertainty, i.e. the higher the weighting, the greater the significance of the corresponding uncertainty to the risk status of the project. The above and/or combination is used to express the possibility that only risks or only uncertainties are present in a project, and therefore only one of the relevant variables is provided and visualized in accordance with the following steps. The provision of the first or second input variables is preferably done by reading the corresponding input variables from a storage means, e.g. a table. The input variables, or variables which are dependent on the input variables and from which the input variables can be determined, are usually specified by people involved in the project, e.g. in the context of workshops.

In the method according to an embodiment, on the basis of the first and/or second input variables, a bar chart is generated with a first sector for the first input variables and/or a second sector for the second input variables, the first and second sectors being visually distinguishable if both are present. A suitable visual distinction between risks and uncertainties is already established thereby. An observer sees the extent to which a project is subject to uncertainties in this case. In particular, if there is a multiplicity of uncertainties in comparison with a smaller number of risks, it is intuitively conveyed that further information is required with regard to the specification of the project, in order that the risk status can be determined more precisely.

In the representation according to an embodiment, for each risk of the number of risks, the first sector (if present) comprises a bar segment in which the probability-of-occurrence variable and the degree-of-damage variable of the relevant risk are depicted in a visually distinguishable manner by means of bars. An observer thus receives detailed information which can be grasped quickly about the classification of a risk. In a similar manner to the first sector, the second sector (if present) comprises a bar segment for each uncertainty of the number of uncertainties, in which the weighting variable and the estimate-of-damage variable are depicted in a visually distinguishable manner by means of bars.

Using the method according to an embodiment, an easily understandable and quickly graspable depiction of the risk status is established on the basis of risks and uncertainties.

By virtue of corresponding visual differentiation, which can be achieved e.g. using various colorings of the bars, detailed information about the project is also conveyed to the observer by means of a single diagram.

For the purpose of quantifying an uncertainty, an embodiment of the method provides for this uncertainty to be ascertained on the basis of a degree of predictability and a degree of influencability. The degree of predictability and the degree of influencability are determined e.g. by people involved in the project in this case. In this embodiment, the step of providing the second input data comprises the reading in of corresponding degrees of predictability and degrees of influencability, in combination with ascertaining a weighting. In this case, the weighting is composed of an unpredictability which is an inverse variable to the degree of predictability, and an uninfluencability which is an inverse variable to the degree of influencability. The degree of predictability and the degree of influencability are used to establish variables that serve to additionally quantify non-calculable risks in a suitable manner. In this case, the degree of predictability expresses how well causes and risk drivers of the corresponding observed uncertainty are known in the project. The degree of influencability expresses how effectively the observed uncertainty can be influenced by people and institutions involved in the project.

In an embodiment, the weighting of a relevant uncertainty in the corresponding bar segment is represented by a bar which is composed of a bar section for the uninfluencability and a bar section for the unpredictability, the two bar sections preferably being visually distinguishable. A representation of the weighting is generated thus in a suitable manner, wherein in particular detailed information relating to the composition of the weighting is also clear.

In a further embodiment of the method, in a bar segment of a relevant risk, a bar in a first direction represents the probability of occurrence and a bar in a second (opposite) direction represents the level of damage. Provision is thus made for visually conveying, in a simple manner, which probability of occurrence and which level of damage belong to the same risk. In a further embodiment of the method, in a bar segment of a relevant uncertainty, a bar in a first direction represents the weighting and a bar in a second (opposite) direction represents the estimate of damage. This embodiment likewise makes provision for visually conveying, in a simple manner, which weighting and which estimate of damage belong to the same uncertainty.

In a further embodiment of the method, those bars representing probabilities of occurrence have a first color. Similarly, those bars representing levels of damage have a second color. Furthermore, those bars representing a weighting have a third color or a pair of colors comprising a fourth and a fifth color. The first to third colors or the first to fifth colors are different colors in this case. It is therefore possible to convey which parameters the individual bars represent, by means of corresponding color-coding. In particular, a distinction between risks and uncertainties is also achieved. In this case, the risk status is visualized for the observer by means of the color coding in such a way that an image which is filled to a greater extent with colors, and in particular a very brightly colored image, corresponds to a project which is subject to a greater extent of risk.

In an embodiment of the method, in which the unpredictability and the uninfluencability are depicted in a corresponding bar by visually distinguishable bar sections, the bar section for the unpredictability has the fourth color and the bar section for the uninfluencability has the fifth color.

A particularly easily and intuitively graspable representation of the risk status is achieved by realizing the bar chart as a circular diagram, wherein the first sector (if present) is a first circle sector and the second sector (if present) is a second circle sector, and a bar segment is provided in the form of a bar circle segment for each risk and/or each uncertainty. The first and second circle sectors are preferably separated from each other by two separation circle segments for the purpose of differentiation.

In a further embodiment of the method, the circular diagram comprises a ring which is visually distinguishable from the bars and is divided into respective ring segments that are assigned to the bar circle segments.

In an embodiment, one bar for the probability of occurrence and one bar for the degree of damage are provided for a respective ring segment which is assigned to a bar circle segment representing a risk, wherein one bar extends outwards from the relevant ring segment in a radial direction of the diagram, and the other bar extends inwards in a radial direction of the diagram. In this case, the bar for the probability of occurrence preferably extends outwards and the bar for the degree of damage preferably extends inwards.

In a further embodiment, one bar for the weighting and one bar for the estimate of damage are provided for a respective ring segment which is assigned to a bar circle segment representing an uncertainty, wherein one bar extends outwards from the relevant ring segment in a radial direction of the circular diagram and the other bar extends inwards in a radial direction of the circular diagram. In this case, the bar for the weighting preferably extends outwards and the bar for the estimate preferably extends inwards.

In a further embodiment, an evaluation of the risk assigned to the ring segment or of the uncertainty assigned to the ring segment is visually depicted in a respective ring segment, e.g. by means of gray shading and/or color shading of the surface of the ring segment. In this way, further information relating to the evaluated risks or uncertainties is visually conveyed to the observer in a suitable manner in the circular bar chart. In contrast to the quantitative variables of the probability of occurrence and the level of damage, or of the weighting and the estimate of damage, the evaluations preferably represent qualitative evaluations of the risks and/or the uncertainties in this case. In particular, these evaluations are intuitive appraisals of the risks or uncertainties based on consultations with the people involved in the project.

In a further embodiment of the method, the circular bar chart comprises an outer ring with respective outer ring segments that are assigned to the bar circle segments for the first and/or second circle sector, wherein a quantitative evaluation of the risk or uncertainty is visualized in the relevant outer ring segments based on the bars of the corresponding bar circle segment, wherein the quantitative evaluation is preferably divided into a plurality of classes and the respective class of the evaluation is preferably depicted by the color of the relevant outer ring segment. As a result of this, a quantitative classification of the corresponding risk or of the corresponding uncertainty is visually conveyed in a suitable manner. In combination with the above embodiment, in which qualitative evaluations are displayed in ring segments, it is thus possible to recognize implausible risks in the diagram when there is a large discrepancy between quantitative and qualitative evaluation.

In a further variant of the method, the background of the circular bar chart is dark and in particular black, wherein the bars stand out from this background by virtue of their coloring. This results in a representation of the risks or uncertainties which is particularly easy to grasp visually.

In a further embodiment, information relating to the technical project is given in the center of the bar chart, e.g. the name of the project, the number of assessed risks or uncertainties and the like.

In a further variant, a scale is visualized in the bars of the bar chart, in particular in the form of continuous circular lines. In this case, a logarithmic scale is preferably visualized for bars which represent degrees of damage or estimates of damage. By contrast, a linear scale is preferably visualized for bars which represent probabilities of occurrence or weightings.

In a further embodiment, the risk status is visualized by the bar chart after planning of measures for reducing the project risk, wherein the risks and/or uncertainties after implementation of the planned measures are visualized by respective bars. In order to allow a comparison between the risks before and after implementation of the planned measures, a further embodiment additionally provides for the risks and/or uncertainties before the implementation of the planned measures to be at least partly visualized in the bar chart. In this case, the visualization is preferably coordinated in such a way that the relevant bars are overlaid with second bars, which depict in each case the variable represented by the respective bar before the implementation of the planned measures, wherein that part of the second bar which extends beyond the relevant bar is depicted such that it can be visually distinguished from the bar concerned. In exceptional cases when the second bar, which depicts corresponding variables before the implementation of the planned measures, is smaller than the bar after implementation of the measures, the visual depictions of the two bars are inverted, thereby conveying in a simple manner to the observer that the exceptional case has occurred in which a risk or uncertainty became greater after the implementation of the planned measures.

In a further embodiment of the method, the measure costs of the planned measures are visualized in the bar chart, e.g. by corresponding markers for the relevant risk or the relevant uncertainty which is to be reduced by the measure, the markers being registered in particular on the corresponding scale for the level of damage or estimate of damage of the risk or uncertainty respectively, such that the extent of the measure costs can be read easily.

In a further embodiment, provision is also made for the user to be able to set markers in the bar chart for the purpose of highlighting risks and/or uncertainties. In this way, those risks considered to be particularly relevant by the user can easily be highlighted.

In addition to the above described method, the invention further relates to a computer program product comprising program code which is stored on a machine-readable medium, for implementing any variant of the above described method when the program runs on a computer.

The method according to various embodiments makes it possible, at any phase of a project for developing or producing a technical system or technical components or a technical process, to visualize in a suitable manner the risks or uncertainties associated with the project, such that the risk status can be grasped easily and intuitively by the observer. The risks and uncertainties are ascertained at an early stage of the project, for example, in order to decide whether the development or production of a technical installation based on the specification of a potential customer should even be started. The initial risks and uncertainties are suitably appraised at this early project stage, the uncertainties (i.e. the non-calculable risks) being predominant. On the basis of a corresponding visualization, which is described in greater detail below, it is then possible to appraise the extent to which further technical specifications or contractual outline conditions must be clarified with the potential customer in order to obtain a realistic picture of the risks that are present. Should the occasion arise, based on the visualization according to various embodiments, it is also already possible at this early project stage to establish that the level of risk and uncertainty is so high that it is not advisable to pursue the project further.

If the project is pursued further, the visualization according to various embodiments of the risk status is usually performed again shortly before submitting an offer to the customer, in order to clarify whether the calculable risks are predominant and whether the extent of the risks and uncertainties indicate that it is advisable to submit an offer accordingly. If applicable, where the risks or uncertainties are too high, no offer is submitted.

If an offer is submitted and the project proceeds into the next phase of actual implementation due to acceptance of the offer by the customer, a corresponding risk appraisal can be carried out again at various times during the implementation, wherein the risks and uncertainties become progressively fewer and the remaining risks can be calculated with ever greater accuracy as the project status advances.

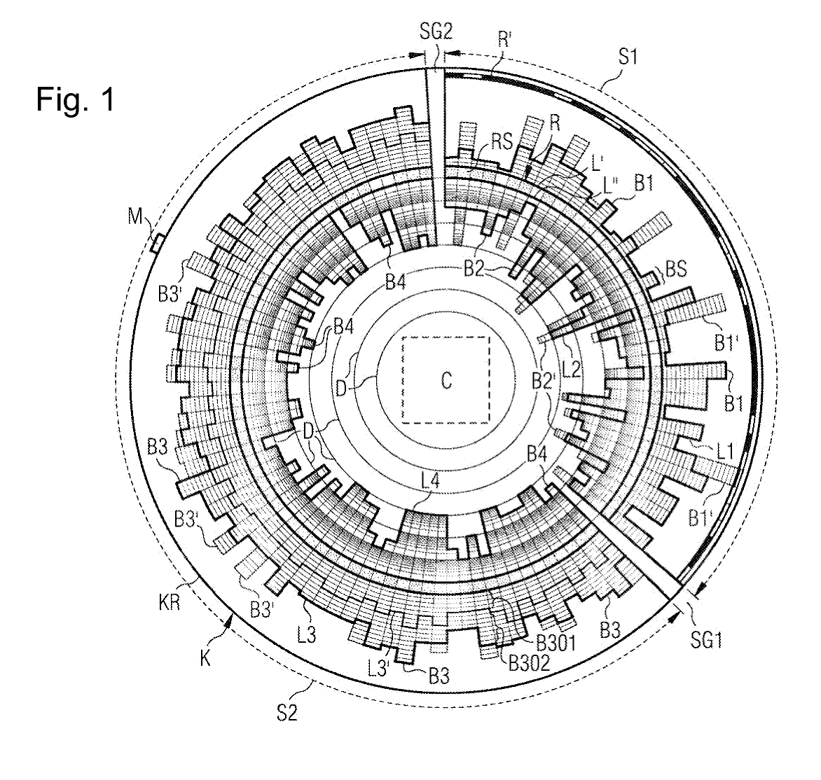

FIG. 1 shows an embodiment of a visualization of a project status based on a circular bar chart which can be presented to a group of people by suitable technical means, e.g. a screen or projector. For the purpose of generating the representation shown, consideration is given to first input variables in the form of a plurality of risks which have been specified beforehand in an appropriate manner by people involved in the project, possibly in workshops. The risks are calculable in this case, and are therefore described arithmetically by a probability of occurrence of the corresponding risk as a percentage and by a degree of damage if the risk occurs. The degree of damage is preferably characterized by a monetary loss. The risks can be formulated as desired, and depend largely on the project. For example, a risk could be the risk of failure of a specific component of a technical system that is to be realized, a corresponding monetary loss being associated with this risk (e.g. the costs of replacing the failed component), and a corresponding probability that these damages will arise.

In addition to the risks as first input variables, consideration is also given to uncertainties in the project, these representing aspects of the project for which not enough information or experience is yet available for exact probabilities of occurrence or levels of damage to be specified. In order nonetheless to obtain a degree of relevance of a corresponding uncertainty, the uncertainties are assigned a weighting and an estimate of damage in each case, these in turn being specified by people involved in the project. The estimate of damage generally corresponds to a monetary loss, whose specification is however considerably less precise than the level of damage for a risk.

For the purpose of weighting a corresponding uncertainty, consideration is given to a degree of influencability of the uncertainty and a degree of predictability of the uncertainty, these in turn being specified by people involved in the project. In this case, corresponding uncertainties with their estimate of damage and their weighting are used as second input variables for the generation of the circular bar chart as per FIG. 1.

The following first explains the meaning of the variables relating to the estimate of damage, the predictability and the influencability, and the factors on which these variables depend. The estimate of damage represents a variable that is analogous to the level of damage for a risk. High estimates of damage therefore represent a high potential threat to the project, irrespective of whether the predictability or the influencability of the corresponding uncertainty is high or not. In this case, the estimate of damage is preferably a qualitative evaluation indicating how high the maximal possible damage can be.

The predictability of an uncertainty expresses how well the causes and risk drivers for the relevant uncertainty are known. In this case, consideration is given to the experience of the employees in the company undertaking the project. If there is already a significant amount of experience from similar projects, the predictability of the corresponding uncertainty is high. If the uncertainty is new to the company undertaking the project, but solutions for avoiding or eliminating the uncertainty are known from the prior art, the predictability is considered to be medium. By contrast, the predictability is classified as low if the uncertainty is classified as completely new.

The influencability variable describes the extent to which the company undertaking the project can apply measures to influence the issue giving rise to the corresponding uncertainty. If the responsibility for the uncertainty lies with a supplier to whom the company undertaking the project has no access, the influencability is classified as very low. If the company has some control over the uncertainty concerned, or has access to a third party who can influence the uncertainty, the influencability is classified as medium. If the uncertainty can be influenced completely by the company undertaking the project, the influencability is classified as high. As mentioned above, the uncertainties and the calculated risks are determined as appropriate by people involved in the project. In this case, the process of specifying the individual variables explained above is not part of the method according to the invention. The method merely uses the corresponding variables as input variables to realize a visualization, which can be grasped quickly, of the overall project risk.

The representation according to FIG. 1, which is based on the input variables explained above, contains a plurality of reference signs and corresponding lines for allocating the reference signs to components of the representation. In this case, the reference signs and the corresponding lines are not part of the representation itself.

The representation comprises a circle K which is delimited by an outer edge KR, wherein the surface of the circle forms the background of the representation, said background being colored black in an embodiment, such that corresponding bars of the bar representation, which are colored in brighter colors, are highlighted particularly effectively. The circle K is divided into two circle sectors S1 and S2, which are separated from each other by two circle segments SG1 and SG2. These segments visualize the boundaries between the two sectors and are depicted in particular in the same color as the background color of the circle K. The sector S1 is used for visualizing the calculable risks of the project and the sector S2 for visualizing the uncertainties. It can be seen that the sector S2 is larger than the sector S1 in the scenario according to FIG. 1, and it can therefore be inferred that a project status is being visualized in an early stage of the project, since the number of uncertainties is very high compared with the calculable risks.

In the intermediate region of the circle K, provision is further made for a ring R which is delimited by an inner outer line L′ and an inner line L″ and is only interrupted by the segments SG1 and SG2. Along this ring R, a pair of bars is provided for each risk and each uncertainty, wherein one bar of the pair extends radially outwards from the ring and the other bar extends radially inwards. In this way, a bar segment is created for each risk and each uncertainty, wherein the extension length of a bar segment is denoted as BS at one position in the diagram. Corresponding to the bar segments, the ring R is similarly divided into individual ring segments, one of which is denoted by reference sign RS in FIG. 1 by way of example.

FIG. 1 shows a project stage in which measures were already planned once previously. In the diagram according to FIG. 1, the risks and uncertainties are depicted both after implementation of the planned measures and before implementation of the planned measures in this case, the risks and/or uncertainties being highlighted more clearly after implementation of the measures than before the implementation of the measures, as explained in greater detail below. If there is no difference between the variables depicted by the bars before and after planned measures, only the bar after implementation of the planned measures is depicted.

The bars which extend radially outwards from the ring R in the sector S1, whose outlines are indicated by a thick continuous line L1 and which for reasons of clarity are only denoted in some cases by the reference sign B1, relate to the probability of occurrence of the corresponding risk after implementation of the planned measures. The bars are depicted in a mid-blue color in this case, and therefore stand out well from the background of the circle K. The higher a bar is, the greater the probability of occurrence, the probability of occurrence being expressed on the basis of a linear scale which is indicated on the individual bars by uniform scale intervals.

On many of the bars, values can also be seen for probabilities of occurrence of risks before implementation of the planned measures. These probabilities of occurrence are normally higher than after successful implementation of measures. In FIG. 1, the difference between probability of occurrence before and after planning measures is indicated by a dark-blue bar which is added on top of the bar after implementation of the planned measures. In FIG. 1, the correspondingly added bars are indicated by dotted lines and are at least in some cases denoted by reference sign B1′. Due to the darker coloring of the bars B1′, the risks before the implementation of the planned measures are not as striking to the eye as the risks after the implementation of the planned measures.

In each bar segment BS in the sector S1, corresponding bars for each segment also extend radially into the center of the circle K. These bars are denoted at least in some cases by the reference sign B2 in FIG. 1, and their outline is depicted by a thick line L2. The bars B2 represent the level of damage of the corresponding risk on a logarithmic scale in this case, wherein the logarithmic scale is visible inside the individual bars. Furthermore, the individual decades of the logarithmic scale are indicated by inner rings D which stand out from the background of the circle K. In contrast with the bars B1, the bars B2 are depicted in a bright-red color and likewise stand out well from the background of the circle K. In a similar manner to the probabilities of occurrence, the corresponding values before implementation of the planned measures are also specified for the levels of damage. These levels of damage are usually higher than after successful implementation of measures, and the difference between the levels of damage before and after implementation of measures is again visualized by means of corresponding bars which are added on top of the bars B2. These added bars are again indicated by means of dotted lines and are denoted at least in some cases by reference sign B2′. In this case, the bars B2′ are a dark-red color and stand out considerably less from the background than the bars B2. Consequently, attention is drawn more strongly in FIG. 1 to the variables after implementation of the planned measures.

The sector S2 relating to the uncertainties of the project is constructed in a similar manner to the sector S1. Provision is again made for a corresponding circle segment for each uncertainty, wherein the bar extending outwards from the ring R now corresponds to a corresponding weighting of the respective uncertainty. These bars are denoted by reference sign B3 in some cases, wherein the outline of these bars is indicated by a corresponding thick line L3. The bars B3 show the weighting after implementation of the planned measures. In a similar manner to the sector S1, the corresponding weightings before implementation of the planned measures are also depicted in the sector S2 by means of bars which are added on top of the bars B3 and which are denoted in FIG. 1 by reference sign B3′ in some cases and indicated by dotted outlines. The color of these added bars is very dark and brownish in this case, such that the weighting before implementation of the planned measures is not very striking to the eye.

The individual bars B3 are composed of an inner bar section and an outer bar section in each case, the boundary between the bar sections being indicated by a line L3′ in FIG. 1. For example, a bar section adjoining the ring R in FIG. 1 is denoted by reference sign B301, and a bar section added on top of it is denoted by reference sign B302. All inner bar sections are depicted in a bright-orange color in this case, and all outer bar sections in a yellow color, such that these bar sections stand out clearly from the background of the circle K.

The inner bar sections B301 relate to the corresponding degree of influencability of the relevant uncertainty, wherein it is not the degree of influencability itself, but an inverse variable of this degree that is depicted as a bar. This means that the higher the bar B301, the greater the uninfluencability, i.e. the smaller the degree of influencability of the corresponding uncertainty. The outer bar B302 relates to the degree of predictability of the relevant uncertainty, wherein it is not the degree of predictability itself, but an inverse variable of this degree that is depicted. This means that the bigger the bar B302, the greater the unpredictability of the corresponding uncertainty. By depicting suitable inverse variables in relation to the degree of predictability and the degree of influencability, a variable is obtained which expresses the relevance of the uncertainty in the form of a weighting and therefore allows a comparison with corresponding probabilities of occurrence of risks in the segment S1.

In the example according to FIG. 1, a bar height of 0 for the uninfluencability signifies a maximal degree of influencability of 2, the degree of influencability being classified in steps of 0.5 between 0 and 2. On the other hand, a bar height of 0 for the unpredictability signifies a maximal degree of predictability of 2, which is likewise specified in steps of 0.5 between 0 and 2. The unpredictability represented by the bar B302 is depicted as (2—degree of predictability) in this case, whereas the uninfluencability depicted by the bar B301 is represented as (2—degree of influencability). It is also possible to use any alternative corresponding encodings of unpredictability and uninfluencability, but the height of the bar must be a function of the uninfluencability and unpredictability of the corresponding uncertainty.

In addition to the bars B3 extending radially outwards, the sector S2 also comprises bars which extend inwards from the ring R and represent the corresponding estimate of damage of the corresponding uncertainty. In this case, the individual estimates of damage are depicted by dark-orange colored bars B4, whose outline is indicated by the thick line L4. In this case, it is again the estimates of damage after implementation of the planned measures that are depicted. By means of bars which are added on correspondingly, it is also possible in this case to depict the estimate of damage before implementation of the planned measures, wherein no added bars are shown in the example according to FIG. 1, signifying that the estimates of damage before and after implementation of the measures are of the same magnitude. In this case, the added bars are represented in a darker color than the bars B4 (e.g. in violet), such that they are less noticeable than the bars B4.

In the example according to FIG. 1, a corresponding logarithmic scale is again visualized within the bar B4, wherein however the height of the bar is not displayed on the basis of this scale, but in a linear manner on the basis of corresponding estimate-of-damage values, which lie between 1 and 3 in intervals of 0.5. The bars B4 allow a comparison to be made between the estimates of damage and the corresponding levels of damage of the risks in the sector S1, since the relevant bars in both sectors S1 and S2 extend radially inwards towards the center of the circle K.

As explained above, in the circular bar chart according to FIG. 1, corresponding parameters relating to the risks and uncertainties (i.e. the probability of occurrence, the weighting, the degree of damage and the estimate of damage) are depicted before and after the implementation of planned measures. If the corresponding parameter is greater before implementation of the measure, this is depicted by means of a bar which is added on top accordingly. If there is no change to the parameter before and after implementation of the planned measure, no added bar is depicted.

If the relatively rare case occurs in which a parameter is higher after the implementation of the planned measures than before the implementation of the planned measures, this is shown by inverting the coloring of the corresponding bar. This means that a correspondingly added bar now represents the growth of the parameter between the time before implementation of the measures and after implementation of the measures. The color for the bar at the time after the implementation of the measures is now used as a color for the added bar in this case. Conversely, the bar to which the bar is added now shows the magnitude of the parameter before the implementation of the measures and also has the color for bars before the implementation of the measures. By means of inverting the colors of the bar which directly adjoins the ring R and the bar which is added on top of it, it is therefore possible to visualize the case in which—unlike the normal case—the parameters are higher after implementation of the measures than before implementation of the measures.

In the example according to FIG. 1, it is also possible to display corresponding measure costs for reducing a corresponding risk or a corresponding uncertainty. This is done by means of a white colored marker (not shown) within the relevant bar segment of the risk or uncertainty concerned, and specifically in the region of the logarithmic scale which extends inwards from the ring, wherein the position of the marker on the scale depicts the corresponding measure costs.

In the example according to FIG. 1, within the individual segments RS of the ring R, provision is further made for depicting corresponding qualitative evaluations by means of suitable gray shading of the surfaces of the ring segments RS for the respective risk or uncertainty concerned. These shades of gray are indicated by corresponding dots in the segments. In this case, the risk or uncertainty is evaluated in steps of 0.5 on a scale of 0 to 5, for example, wherein the darkness of the gray shading indicates the relevance and noteworthiness of the risk or uncertainty. The shade of gray can vary between white for a very low evaluation to dark black for a very high evaluation, with shades of gray between the two.

In the example according to FIG. 1, an outer ring R′ is also depicted in the segment S1 and lies adjacent to the circle perimeter KR of the circle K. This ring is again divided into individual segments for the individual risks, wherein the individual segments are color-coded and express by means of corresponding colors a categorization of the risk based on the probability of occurrence and level of damage of the risk. In particular, the coloring is based on a quantitative risk value comprising the product of probability of occurrence and level of damage. This risk value is divided into the categories “low risk”, “medium risk” and “high risk” for different value ranges, wherein the corresponding risk category is expressed by colors in the segments of the outer ring R′. In particular, a red color signifies a high risk, a yellow color a medium risk and a green color a low risk in this case. For reasons of clarity, the coloring is visualized merely by black and white segments within the outer ring R′ in FIG. 1.

In the representation according to FIG. 1, by means of corresponding interaction via a user interface, the user can also set markers in the representation in the form of colored bars at corresponding bar segments whose uncertainties or risks are highly significant to the project in the opinion of the user. Such a set marker is denoted by reference sign M in FIG. 1, for example.

In the center of the circular bar chart, this being indicated by the reference sign C and a corresponding broken-line rectangle, it is also possible to display corresponding information relating to the project, in particular the project name, the number of risks, the number of uncertainties and other relevant parameters for the project. Like the input variables for risk and uncertainty, this data can be read from a corresponding table if appropriate, and depicted in a bright color to stand out against the dark background of the circle K.

By representing risks and uncertainties in the form of an iris as per the embodiment in FIG. 1, the extent to which the project is subject to risk in the current project stage is conveyed to the observer in a simple and intuitive manner. In particular, by virtue of the different colorings of the individual bars, the division of risks relative to uncertainties is quickly visualized. Moreover, the extent of the uncertainties or risks is visualized by the magnitude of the bars. In particular, it is clear that a more colorful and fuller circle K represents a higher risk status of the project accordingly.

The representation as per FIG. 1 also makes it possible quickly to recognize which risks or uncertainties are particularly relevant, since the bars which extend correspondingly inwards and outwards are particularly long for such risks and uncertainties. Moreover, the intermediate ring R also visualizes a qualitative evaluation of the risks, which can be compared with the corresponding quantitative evaluations based on the bars. As a result, the plausibility of the corresponding risk or uncertainty can easily be seen in the extent to which the qualitative evaluation, which is often merely based on a subjective feeling of corresponding people involved in the project, correlates to a quantitative evaluation of the risk or uncertainty.

Furthermore, the profile of the risk or uncertainty is immediately visible for each risk or uncertainty, since the corresponding parameters of the risk (i.e. the level of damage and the probability of occurrence) or the corresponding parameters of the uncertainty (i.e. the uninfluencability, the unpredictability and the estimate of damage) are apparent.

What is claimed is:

1. A method for the computer-aided visualization of the risk status in a technical project for developing or producing a technical system, technical components or a technical process, the method comprising the steps of:
providing at least one of a number of risks as first input variables and a number of uncertainties as second input variables, each risk being assigned a probability of occurrence and a degree of damage if the risk occurs and each uncertainty being assigned a weighting and an estimate of damage if the uncertainty occurs; and
generating and displaying a bar chart having at least one of a first sector for the first input variables and a second sector for the second input variables on the basis of at least one of the first and second input variables, wherein the first and second sectors are visually distinguishable;
wherein for each risk of the number of risks, the first sector comprises a bar segment in which the probability-of-occurrence variable and the degree-of-damage variable of the relevant risk are depicted in a visually distinguishable manner by means of bars; and
wherein for each uncertainty of the number of uncertainties, the second sector comprises a bar segment in which the weighting variable and the estimate-of-damage variable are depicted in a visually distinguishable manner by means of bars.

2. The method according to claim 1, wherein the weighting of a particular uncertainty is ascertained on the basis of a degree of predictability and a degree of influencability, wherein the weighting is composed of an unpredictability which is an inverse variable to the degree of predictability, and an uninfluencability which is an inverse variable to the degree of influencability.

3. The method according to claim 2, wherein the weighting of a particular uncertainty in the corresponding bar segment is represented by a bar which is composed of a bar section for the uninfluencability and a bar section for the unpredictability, wherein the two bar sections are visually distinguishable.

4. The method according to claim 1, wherein a bar in a first direction represents the probability of occurrence and a bar in a second, opposite direction represents the level of damage, within a bar segment of a relevant risk.

5. The method according to claim 1, wherein a bar in a first direction represents the weighting and a bar in a second, opposite direction represents the estimate of damage, within a bar segment of a relevant uncertainty.

6. The method according to claim 1, wherein in the bar chart
those bars representing probabilities of occurrence have a first color;
those bars representing levels of damage have a second color;
those bars representing weightings have a third color or a pair of colors comprising a fourth and fifth color;
wherein the first to third colors or the first to fifth colors are different colors.

7. The method according to claim 3, wherein in the bar chart
those bars representing probabilities of occurrence have a first color;
those bars representing levels of damage have a second color;
those bars representing weightings have a third color or a pair of colors comprising a fourth and fifth color;
wherein the first to third colors or the first to fifth colors are different colors;
and wherein the bar section for the uninfluencability has the fourth color and the bar section for the unpredictability has the fifth color.

8. The method according to claim 1, wherein the bar chart is a circular diagram, wherein at least one of the first sector is a first circle sector and the second sector is a second circle sector, and a bar segment in the form of a bar circle segment is provided for at least one of each risk and each uncertainty.

9. The method according to claim 8, wherein the first and second circle sectors are separated from each other by two separation circle segments.

10. The method according to claim 8, wherein the circular diagram comprises a ring that is visually distinguishable from the bars and is divided into respective ring segments which are assigned to the bar circle segments.

11. The method according to claim 10, wherein one bar for the probability of occurrence and one bar for the degree of damage are provided for a respective ring segment which is assigned to a bar circle segment representing a risk, wherein one bar extends outwards from the relevant ring segment in a radial direction of the circular diagram, and the other bar extends inwards in a radial direction of the circular diagram.

12. The method according to claim 10, wherein one bar for the weighting and one bar for the estimate of damage are provided for a respective ring segment which is assigned to a bar circle segment representing an uncertainty, wherein one bar extends outwards from the relevant ring segment in a radial direction of the circular diagram and the other bar extends inwards in a radial direction of the circular diagram.

13. The method according to claim 10, wherein an evaluation of the risk assigned to the ring segment or of the uncertainty assigned to the ring segment is visually depicted in a respective ring segment.

14. The method according to claim 13, wherein the visual depiction of the evaluation is achieved by means of at least one of gray shades and color shades of the surface of the ring segment.

15. The method according to claim 13, wherein the evaluations are qualitative evaluations of at least one of the risks and the uncertainties.

16. The method according to claim 8, wherein the circular diagram comprises an outer ring with respective outer ring segments that are assigned to the bar circle segments for the at least one of first and second circle sector, wherein a quantitative evaluation of the risk or uncertainty is visualized in the relevant outer ring segments based on the bars of the corresponding bar circle segment, wherein the quantitative evaluation is divided into a plurality of classes and the respective class of the evaluation is depicted by the color of the relevant outer ring segment.

17. The method according to claim 8, wherein the background of the circular diagram is dark or black, and the bars stand out from this background by virtue of their coloring.

18. The method according to claim 8, wherein information about the technical project is given in the center of the circular diagram.

19. The method according to claim 1, wherein a scale or a scale in the form of continuous circular lines, is visualized in the bars of the bar chart.

20. The method according to claim 19, wherein a logarithmic scale is visualized in bars that represent degrees of damage or estimates of damage, and a linear scale is visualized in bars that represent probabilities of occurrence or weightings.

21. The method according to claim 1, wherein the risk status after planning of measures to reduce the project risk is visualized in the bar chart, wherein at least one of the risks and uncertainties after implementation of the planned measures are visualized by respective bars.

22. The method according to claim 21, wherein at least some of the risks and/or uncertainties before the implementation of the planned measures are visualized in the bar chart.

23. The method according to claim 22, wherein the relevant bars are overlaid by second bars that depict in each case the variable represented by the respective bar before the implementation of the planned measures, wherein that part of a respective second bar which extends beyond the bar concerned is depicted such that it can be visually distinguished from the bar concerned.

24. The method according to claim 23, wherein the visual representations of the two bars are inverted in the event that the respective second bar is lower than the bar concerned.

25. The method according to claim 21, wherein the measure costs of the planned measures are visualized in the bar chart.

26. The method according to claim 1, wherein a user can set markers in the bar chart for the purpose of highlighting at least one of risks and uncertainties.

27. A computer program product comprising program code which is stored on a machine-readable medium which when executed on a computer performs the steps of:
providing at least one of a number of risks as first input variables and a number of uncertainties as second input variables, each risk being assigned a probability of occurrence and a degree of damage if the risk occurs and each uncertainty being assigned a weighting and an estimate of damage if the uncertainty occurs; and
generating and displaying a bar chart having at least one of a first sector for the first input variables and a second sector for the second input variables on the basis of at least one of the first and second input variables, wherein the first and second sectors are visually distinguishable;
wherein for each risk of the number of risks, the first sector comprises a bar segment in which the probability-of-occurrence variable and the degree-of-damage variable of the relevant risk are depicted in a visually distinguishable manner by means of bars; and
wherein for each uncertainty of the number of uncertainties, the second sector comprises a bar segment in which the weighting variable and the estimate-of-damage variable are depicted in a visually distinguishable manner by means of bars.
